(19) United States
(12) Patent Application Publication
(10) Pub. No.: US 2026/0192858 A1
(43) Pub. Date: Jul. 9, 2026

(54) VEHICLE STRUCTURE

(71) Applicant: Honda Motor Co., Ltd., Tokyo (JP)

(72) Inventors: Takumi ISHIKAWA, Tokyo (JP); Masato YOSHIMURA, Tokyo (JP)

(73) Assignee: Honda Motor Co., Ltd., Tokyo (JP)

(21) Appl. No.: 19/420,788

(22) Filed: Dec. 16, 2025

(30) Foreign Application Priority Data
Jan. 3, 2025 (CN) 202510011363.3

(51) Int. Cl. B62D 21/11; B60G 7/02

(52) U.S. Cl. CPC B62D 21/11; B60G 7/02

(57) ABSTRACT

A vehicle structure includes a subframe having a preset bending position and bending at the bending position in an up-down direction when subjected to a load equal to or higher than a preset set value, a lower arm fastened to the subframe by two lower arm fastening portions,, and a lower arm fastening structure fastening the lower arm to the subframe on at least one of the two lower arm fastening portions, and including a lower arm support component supporting the lower arm and a bracket connecting and fixeing the lower arm support component and the subframe. The lower arm support component extends along an axial direction and supports the lower arm by rotatable a manner in the axial direction. The bracket supports the lower arm support component in the up-down direction and has an open cross section opening toward the lower arm support component in the up-down direction.

### CROSS-REFERENCE TO RELATED APPLICATION

This application claims the priority benefit of China application serial no. 202510011363.3, filed on January 3, 2025. The entirety of the above-mentioned patent application is hereby incorporated by reference herein and made a part of this specification.

### BACKGROUND

### Technical Field

The disclosure relates to a vehicle structure.

### Related Art

In recent years, efforts to provide access to sustainable transportation systems that also consider vulnerable traffic participants such as elderly people, physically challenged people, or children are becoming active. To achieve this purpose, research aimed at further improving traffic safety and convenience through development related to collision safety performance has been conducting. However, in technologies related to the collision safety performance, a collision absorption effect of a vehicle structure is an issue.

For example, in the prior art (for example, Japanese Patent Publication No. 2009-179243), a vehicle is provided with a vehicle structure that performs collision absorption by causing a subframe to deform when subjected to collision. In particular, the vehicle structure may control collision absorption capacity by causing the subframe to bend at a preset bending position when subjected to collision, for example, by providing a fragile portion at the bending position of the subframe, so that the subframe undergoes bending deformation through collision input. However, in a situation where the fragile portion is provided between the subframe and a fastening point of the lower arm, if a fastening point of the lower arm has high rigidity in the bending direction when the subframe bends due to collision input, the bending deformation of the subframe is obstructed by the lower arm. Therefore, sufficient collision absorption may not be achieved. Thus, it is necessary to improve the vehicle structure, so that the vehicle structure may reduce the influence of the lower arm when subjected to collision and improve the collision absorption capacity of the subframe.

The disclosure aims to achieve the vehicle structure capable of improving the collision absorption effect in order to solve the aforementioned issue, thereby contributing to the development of sustainable transportation systems.

### SUMMARY

The disclosure provides a vehicle structure capable of improving a collision absorption effect.

The disclosure provides a vehicle structure including a subframe having a bending position which is preset and bending at the bending position in an up-down direction when subjected to a load equal to or higher than a preset value, a lower arm fastened to the subframe by two lower arm fastening portions, where the two lower arm fastening portions are provided across the bending position in a front-rear direction, and a lower arm fastening structure fastening the lower arm to the subframe on at least one of the two lower arm fastening portions, where the lower arm fastening structure includes a lower arm support component supporting the lower arm, and a bracket connecting and fixing the lower arm support component and the subframe. The lower arm support component extends along an axial direction and supports the lower arm by a rotatable manner in the axial direction. The bracket supports the lower arm support component in the up-down direction and has an open cross section opening toward the lower arm support component in the up-down direction.

Based on the above, in the vehicle structure of the disclosure, the lower arm is fastened to the subframe by the two lower arm fastening portions disposed at positions separated by the bending position of the subframe in the front-rear direction. The lower arm fastening structure fastens the lower arm to the subframe on at least one of the two lower arm fastening portions, where the lower arm support component of the lower arm fastening structure supports the lower arm, and the bracket of the lower arm fastening structure connects and fixes the lower arm support component and the subframe. In particular, the bracket supports the lower arm support component from the up-down direction and has an open cross section that opens toward the lower arm support component. As such, the subframe may bend at the bending position between the two lower arm fastening portions when the vehicle structure is subjected to collision and absorb the collision. Moreover, the bracket provides sufficient strength through the open cross section to resist input under general situations, and undergoes torsional deformation to reduce structural strength when subjected to axial torque load generated by deformation of the subframe during collision. If the bracket starts to deform due to collision load, the influence of the lower arm may be reduced and the collision absorption capacity of the subframe may be improved. Accordingly, the vehicle structure of the disclosure may improve the collision absorption effect.

In order to make the above-mentioned features and advantages of the disclosure comprehensible, embodiments accompanied with drawings are described in detail below.

### BRIEF DESCRIPTION OF THE DRAWINGS

FIG. 1 is a perspective schematic view of a vehicle structure according to an embodiment of the disclosure.

FIG. 2 is a schematic front view of the vehicle structure shown in FIG. 1.

FIGS. 3 and FIG. 4 are partial enlarged schematic views of a surrounding area of a lower arm fastening structure of the vehicle structure shown in FIG. 1 from different viewing angles.

FIG. 5 is a perspective schematic view of the lower arm fastening structure used in the vehicle structure shown in FIG. 1.

FIG. 6 is a schematic cross-sectional view of the lower arm fastening structure shown in FIG. 5.

### DESCRIPTION OF THE EMBODIMENTS

The disclosure provides a vehicle structure including a subframe having a bending position which is preset and bending at the bending position in an up-down direction when subjected to a load equal to or higher than a preset value, a lower arm fastened to the subframe by two lower arm fastening portions, where the two lower arm fastening portions are provided across the bending position in a front-rear direction, and a lower arm fastening structure fastening the lower arm to the subframe on at least one of the two lower arm fastening portions, where the lower arm fastening structure includes a lower arm support component supporting the lower arm, and a bracket connecting and fixing the lower arm support component and the subframe. The lower arm support component extends along an axial direction and supports the lower arm by a rotatable manner in the axial direction. The bracket supports the lower arm support component in the up-down direction and has an open cross section opening toward the lower arm support component in the up-down direction.

In an embodiment of the disclosure, the lower arm fastening structure is disposed on one of the two lower arm fastening portions which is closer to the bending position.

In an embodiment of the disclosure, the bracket has a wall portion. The wall portion extends perpendicularly to the axial direction of the lower arm support component and joins to the lower arm support component.

In an embodiment of the disclosure, the bracket has a rib portion. The rib portion extends from the wall portion along the axial direction and joins to the lower arm support component.

In an embodiment of the disclosure, the bracket has a through hole located on a lowermost portion in the up-down direction.

In an embodiment of the disclosure, the bracket includes an upper bracket supporting the lower arm support component from an upper side in the up-down direction, and a lower bracket supporting the lower arm support component from a lower side in the up-down direction. The upper bracket and the lower bracket are fastened to the subframe.

In an embodiment of the disclosure, the lower arm support component includes a sleeve portion surrounding an outer peripheral side of the lower arm, and an outer cylinder surrounding an outer peripheral side of the sleeve portion. The lower arm support component supports the lower arm with the sleeve portion and connects the bracket with the outer cylinder.

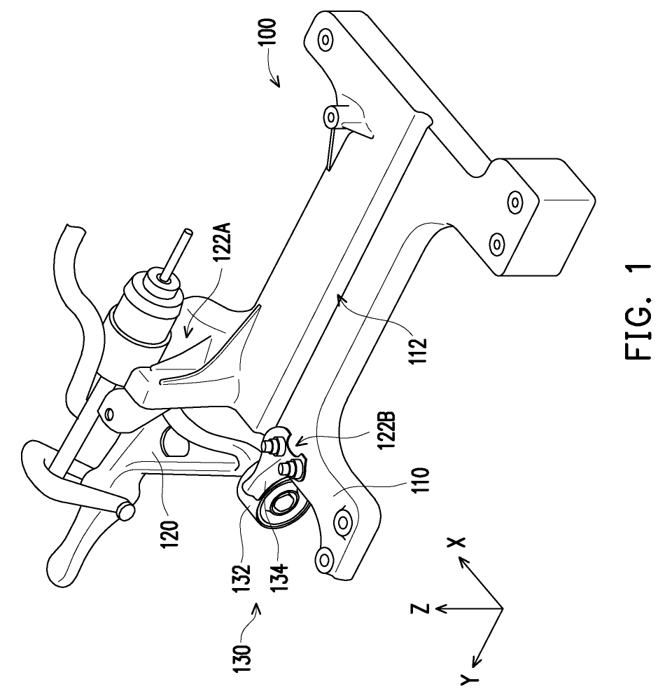

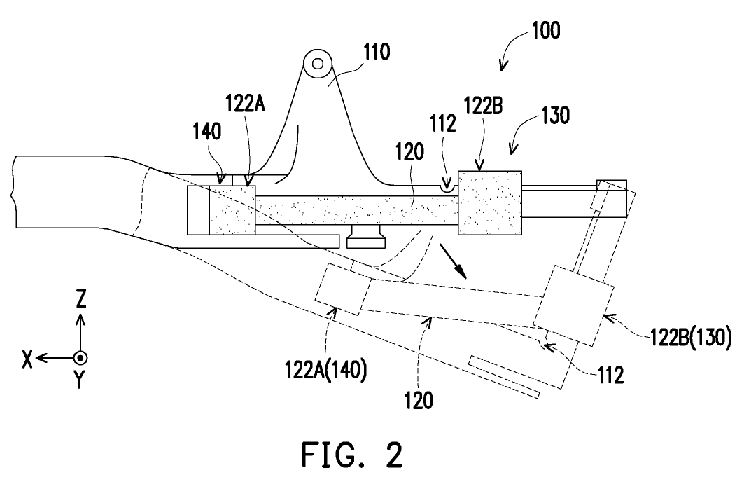

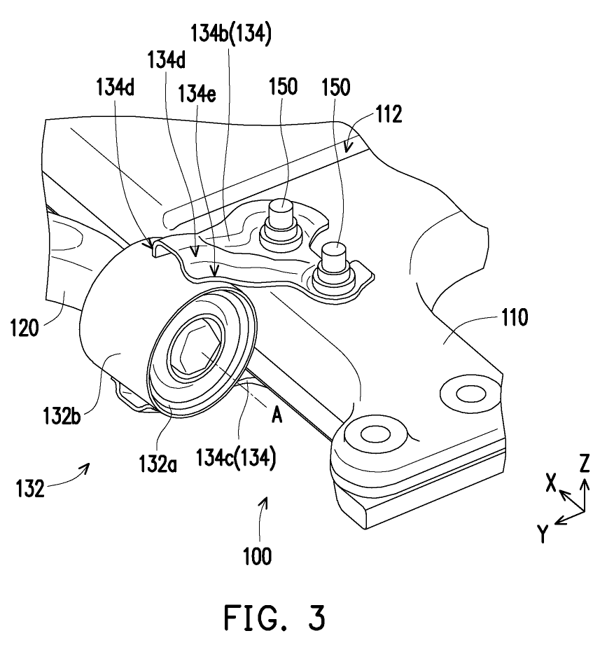

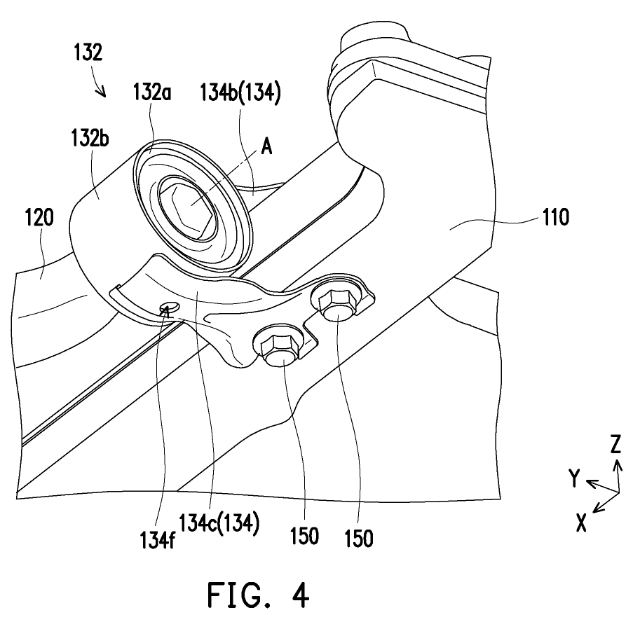

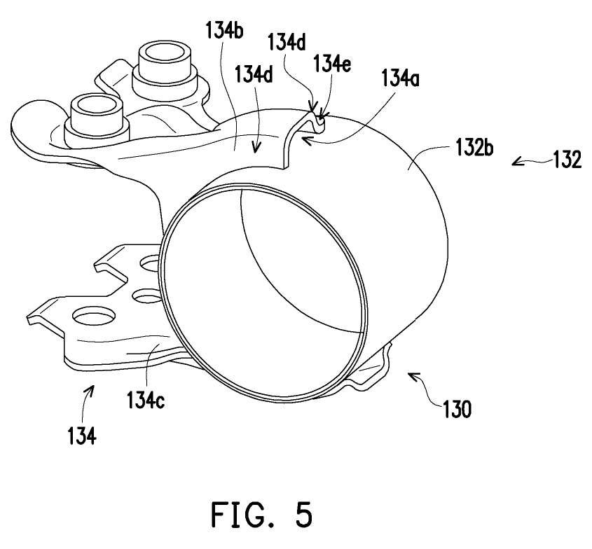

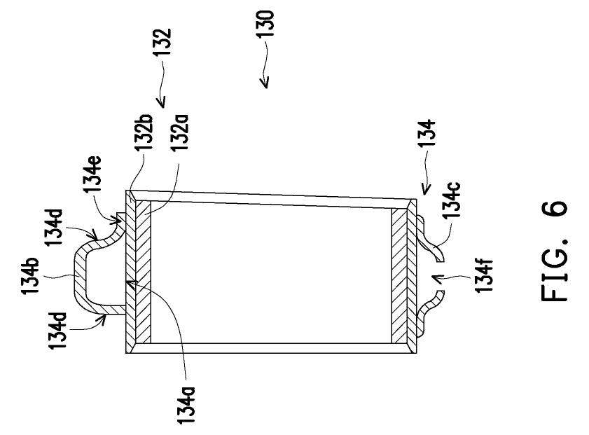

Reference is now made in detail to exemplary embodiments of the disclosure, and examples of the exemplary embodiments are described in the accompanying drawings. FIG. 1 is a perspective schematic view of a vehicle structure according to an embodiment of the disclosure. FIG. 2 is a schematic front view of the vehicle structure shown in FIG. 1. FIGS. 3 and FIG. 4 are partial enlarged schematic views of a surrounding area of a lower arm fastening structure of the vehicle structure shown in FIG. 1 from different viewing angles. FIG. 5 is a perspective schematic view of the lower arm fastening structure used in the vehicle structure shown in FIG. 1. FIG. 6 is a schematic cross-sectional view of the lower arm fastening structure shown in FIG. 5. The specific structure of a vehicle structure 100 of the present embodiment is described below with reference to FIGS. 1 to FIG. 6, but this is only one example of the disclosure, which may be adjusted according to requirements.

Referring to FIGS. 1 and FIG. 2, in this embodiment, the vehicle structure 100 includes a subframe 110, a lower arm 120, and a lower arm fastening structure 130. The subframe 110 has a bending position 112 which is preset, and bends at the bending position 112 along an up-down direction Z (as shown by an arrow direction in FIG. 2) when subjected to a load equal to or higher than a preset value (that is, when collided). The lower arm 120 is fastened to the subframe 110 by two lower arm fastening portions 122A and 122B. The two lower arm fastening portions 122A and 122B are disposed across the bending position 112 in a front-rear direction X (as shown in FIG. 2). The lower arm fastening structure 130 fastens the lower arm 120 to the subframe 110 on at least one of the two lower arm fastening portions 122A and 122B. The lower arm fastening structure 130 includes a lower arm support component 132 that supports the lower arm 120, and a bracket 134 that connects and fixes the lower arm support component 132 and the subframe 110 (as shown in FIG. 1). The lower arm support component 132 extends along an axial direction A thereof, and supports the lower arm 120 by a rotatable manner in the axial direction A. The bracket 134 supports the lower arm support component 132 in the up-down direction Z, and has an open cross section 134a that opens toward the lower arm support component 132 in the up-down direction Z.

Specifically, in this embodiment, as shown in FIGS. 1 and FIG. 2, the subframe 110 is, for example, a frame structure extending in the left-right direction Y, and is connected to the lower arm 120 at relatively two end portions (one end portion is shown in FIG. 1). The bending position 112 of the subframe 110 is disposed at a part substantially central and toward the rear side in the front-rear direction X of the subframe 110, so as to transfer load from the front side toward the bending position 112 when subjected to a load equal to or higher than the preset value (that is, when subjected to front collision), which causes the bending position 112 to bend and deform (the arrow direction in FIG. 2 shows downward bending deformation) upward or downward along the up-down direction Z. The lower arm 120 is, for example, a frame structure extending in the front-rear direction X, and is disposed at relatively two end portions (the lower arm 120 disposed at one end portion is shown in FIG. 1) of the subframe 110. The relatively two end portions of the lower arm 120 in the front-rear direction X are respectively provided with the two lower arm fastening portions 122A and 122B, so that when viewing the vehicle structure 100 (as shown in FIG. 2) in the left-right direction Y, the lower arm 120 and the subframe 110 partially overlap in the front-rear direction X, and the two lower arm fastening portions 122A and 122B are disposed across the bending position 112 in the front-rear direction X. However, the disclosure does not limit the specific structures of the subframe 110 and the lower arm 120, and the disposing positions thereof, which may be adjusted according to requirements.

Furthermore, in this embodiment, as shown in FIGS. 1 and FIG. 2, the lower arm 120 is fastened to the subframe 110 by the lower arm fastening structure 130 disposed at one (for example, the lower arm fastening portion 122B located on the rear side) of the two lower arm fastening portions 122A and 122B. In contrast, the lower arm 120 is fastened to the subframe 110 by the fastening element 140 disposed at the other (for example, the lower arm fastening portion 122A located on the front side) of the two lower arm fastening portions 122A and 122B. As shown in FIGS. 3 to FIG. 6, the lower arm support component 132 of the lower arm fastening structure 130 is, for example, a substantially cylindrical structure extending along the axial direction A thereof. One end portion of the lower arm 120 passes through the lower arm support component 132 and is supported by the lower arm support component 132 surrounding an outer peripheral side thereof. The lower arm support component 132 extends substantially horizontally. The bracket 134 of the lower arm fastening structure 130 is, for example, a substantially annular structure surrounding an outer peripheral side of the lower arm support component 132, to support the lower arm support component 132 in the up-down direction Z, and has an open cross section 134a (for example, substantially C-shaped). Moreover, a part of the bracket 134 opposite to the part supporting the lower arm support component 132 is fastened on the subframe 110 by the fixing element 150 (for example, a bolt). However, in other embodiments not shown, the lower arm fastening structure 130 mentioned above may also be disposed on the lower arm fastening portion 122A located on the front side, or on the two lower arm fastening portions 122A and 122B. The disclosure does not limit the specific structure, disposing position, and number of the lower arm fastening structure 130, which may be adjusted according to requirements.

Through the above arrangement, in the vehicle structure 100 of the this embodiment, the lower arm 120 is fastened to the subframe 110 by the two lower arm fastening portions 122A and 122B disposed across the bending position 112 of the subframe 110 in the front-rear direction X, and the lower arm fastening structure 130 fastens the lower arm 120 to the subframe 110 on at least one (for example, the lower arm fastening portion 122B located on the rear side) of the two lower arm fastening portions 122A and 122B. The lower arm support component 132 of the lower arm fastening structure 130 supports the lower arm 120, and the bracket 134 of the lower arm fastening structure 130 connects and fixes the lower arm support component 132 and the subframe 110. In particular, the bracket 134 supports the lower arm support component 132 in the up-down direction Z and has an open cross section 134a that opens toward the lower arm support component 132. Thus, the subframe 110 may bend at the bending position 112 between the two lower arm fastening portions 122A and 122B when the vehicle structure 100 is subjected to collision (for example, front collision) to absorb collision. Moreover, the bracket 134 provides sufficient strength through the open cross section 134a to resist input under general situations, and undergoes torsional deformation to reduce structural strength when subjected to axial torque load generated by deformation of the subframe 110 during collision. If the bracket 134 begins to deform through collision load, the influence of the lower arm 120 may be reduced to improve the collision absorption capacity of the subframe 110. Accordingly, the vehicle structure 100 may improve a collision absorption effect.

Moreover, in this embodiment, as shown in FIGS. 1 and FIG. 2, one (for example, the lower arm fastening portion 122B located on the rear side) of the two lower arm fastening portions 122A and 122B that is closer to the bending position 112 is provided with the lower arm fastening structure 130. As an example, the bending position 112 of the subframe 110 is disposed at the part substantially central and toward the rear side in the front-rear direction X of the subframe 110. When the lower arm 120 is fastened to the subframe 110, the lower arm fastening portion 122A located on the front side is away from the bending position 112 and the lower arm fastening portion 122B located on the rear side is close to the bending position 112. When the vehicle structure 100 is subjected to collision (for example, front collision), the subframe 110 undergoes bending deformation at the bending position 112, particularly generating larger torsional deformation on the lower arm fastening portion 122B close to the bending position 112. Thus, it is preferable to dispose the lower arm fastening structure 130 including the lower arm support component 132 and the bracket 134 on the lower arm fastening portion 122B that is closer to the bending position 112 of the two lower arm fastening portions 122A and 122B, so that the bracket 134 may reduce the influence of the lower arm 120 on the lower arm fastening portion 122B where larger torsional deformation occurs and effectively absorb collision in the subframe 110. However, the disclosure does not limit the disposing position and number of the lower arm fastening structure 130, which may be adjusted according to requirements.

Furthermore, in this embodiment, as shown in FIGS. 3 to FIG. 6, the lower arm support component 132 includes a sleeve portion 132a (omitted in FIG. 5; referring to FIGS. 3, FIG. 4, and FIG. 6) surrounding the outer peripheral side of the lower arm 120, and an outer cylinder 132b surrounding the outer peripheral side of the sleeve portion 132a. The sleeve portion 132a is, for example, a sleeve formed of materials such as rubber or resin. The lower arm support component 132 supports the lower arm 120 with the sleeve portion 132a, and connects the bracket 134 with the outer cylinder 132b. The sleeve portion 132a and the outer cylinder 132b are configured as cylindrical structures extending along the axial direction A. The lower arm support component 132 and the lower arm 120 may rotate relatively along the axial direction A. Thus, when the vehicle structure 100 is subjected to collision (for example, front collision), the bracket 134 is affected by the bending deformation of the subframe 110 and undergoes torsional deformation, which may effectively absorb collision. However, the disclosure does not limit the specific structure of the lower arm support component 132, which may be adjusted according to requirements.

Additionally, in this embodiment, as shown in FIGS. 3 to FIG. 6, the bracket 134 includes an upper bracket 134b that supports the lower arm support component 132 from an upper side in the up-down direction Z, and a lower bracket 134c that supports the lower arm support component 132 from a lower side in the up-down direction Z. The upper bracket 134b and the lower bracket 134c are fastened and disposed on the subframe 110. As an example, the upper bracket 134b and the lower bracket 134c are each configured as arc-shaped structures, and are disposed facing each other to form an open cross section 134a (as shown in FIG. 5). The upper bracket 134b is fastened to the upper side (as shown in FIG. 3) of the subframe 110 by the fixing elements 150 (for example, the bolts), and the lower bracket 134c is fastened to the lower side (as shown in FIG. 4) of the subframe 110 by the fixing elements 150 (for example, the bolts). Thus, the bracket 134 may start torsional deformation from the open end when the vehicle structure 100 is subjected to collision, thereby improving the collision absorption effect. However, the disclosure does not limit the specific structure (that is, not to limit the specific structures, disposing positions, and whether or not to dispose the upper bracket 134b and the lower bracket 134c) of the bracket 134, which may be adjusted according to requirements.

Further, in this embodiment, as shown in FIGS. 3 to FIG. 6, the bracket 134 has a wall portion 134d. The wall portion 134d extends perpendicularly to the axial direction A of the lower arm support component 132, and joins to the lower arm support component 132. As an example, the wall portion 134d is disposed on the upper side (that is, the aforementioned upper bracket 134b) of the bracket 134 and extends along a circumferential direction of the lower arm support component 132 (the outer cylinder 132b thereof), thereby increasing the contact area and joining strength when the bracket 134 joins to the lower arm support component 132 by the wall portion 134d. Moreover, a pair of wall portions 134d are disposed on the opposite front and rear end portions of the bracket 134, making the cross section of the bracket 134 configured as a lid shape (as shown in FIGS. 3 to FIG. 6). In this way, the bracket 134 may collapse through the lid-shaped structure formed by the wall portion 134d when the subframe 110 undergoes bending deformation and torque load is input, thereby enabling reduction of torsional rigidity and effective absorption of impact. Besides, the bracket 134 connects to the lower arm support component 132 only by the wall portion 134d, and when the design such as the diameter of the lower arm support component 132 is changed, the structural design of the bracket 134 may be easily changed by adjusting only the size or shape of the wall portion 134d, which improves the versatility of the lower arm fastening structure 130.

Additionally, in this embodiment, as shown in FIGS. 3 to FIG. 6, the bracket 134 has a rib portion 134e. The rib portion 134e extends from the wall portion 134d along the axial direction A, and joins to the lower arm support component 132 (the outer cylinder 132b thereof). As an example, the rib portion 134e extends outward from the joining end portion corresponding to the lower arm support component 132 of at least one of the pair of wall portions 134d, and extends along the circumferential direction of the lower arm support component 132 to be configured as an arc-shaped rib structure. Thus, the bracket 134 easily joins to the lower arm support component 132 by the wall portion 134d, and improves the joining strength with the lower arm support component 132 through the provision of the rib portion 134e. Furthermore, the bracket 134 may easily adjust the torsional rigidity of the bracket 134 by adjusting the extension amount of the rib portion 134e. In other embodiments not shown, the rib portion 134e may also be provided on both of the pair of wall portions 134d. However, the disclosure does not limit the specific structure (that is, not to limit the specific structures, disposing positions, and whether to dispose the wall portion 134d and rib portion 134e) of the bracket 134, which may be adjusted according to requirements.

Furthermore, in this embodiment, as shown in FIGS. 3 to FIG. 6, the bracket 134 has a through hole 134f located on the lowermost portion in the up-down direction Z. As an example, the through hole 134f is disposed on the lower bracket 134c mentioned above, and penetrates a bottom surface of the lower bracket 134c to communicate with the open cross section 134a (as shown in FIG. 6) of the bracket 134. Thus, even if water or object invades through the bracket 134 having the open cross section 134a, it may be discharged through the through hole 134f on the lowermost portion of the bracket 134, to avoid damage to components (for example, the bracket 134) of the vehicle structure 100 due to rust. However, the disclosure does not limit the specific structure (that is, not to limit the specific structure, disposing position, and whether to dispose the through hole 134f) of the bracket 134, which may be adjusted according to requirements.

To sum up, in the vehicle structure of the disclosure, the lower arm is fastened to the subframe by the two lower arm fastening portions disposed at positions separated by the bending position of the subframe in the front-rear direction. The lower arm fastening structure fastens the lower arm to the subframe on at least one of the two lower arm fastening portions, where the lower arm support component of the lower arm fastening structure supports the lower arm, and the bracket of the lower arm fastening structure connects and fixes the lower arm support component and the subframe. In particular, the bracket supports the lower arm support component in the up-down direction, and has the open cross section opening toward the lower arm support component. As such, the subframe may bend at the bending position between the two lower arm fastening portions when the vehicle structure is subjected to collision to absorb the collision. Moreover, the bracket provides sufficient strength through the open cross section to resist input under general situations, and undergoes torsional deformation to reduce structural strength when subjected to axial torque load generated by deformation of the subframe during collision. If the bracket begins to deform due to collision load, the influence of the lower arm may be reduced and the collision absorption capacity of the subframe may be improved. Preferably, the one of the two lower arm fastening portions closer to the bending position is provided with the lower arm fastening structure, so that the bracket of the lower arm fastening structure may generate greater torsional deformation on the part close to the bending position, improving the collision absorption capacity of the subframe. Accordingly, the vehicle structure of the disclosure may improve the collision absorption effect.

Finally, it should be noted that the above embodiments are only used to illustrate, but not to limit, the technical solutions of the disclosure. Although disclosure has been described in detail with reference to above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A vehicle structure, comprising:
a subframe, having a bending position which is preset and configured to bend at the bending position in an up-down direction when subjected to a load equal to or higher than a preset value;
a lower arm, fastened to the subframe by two lower arm fastening portions, the two lower arm fastening portions being provided across the bending position in a front-rear direction; and
a lower arm fastening structure, fastening the lower arm to the subframe on at least one of the two lower arm fastening portions, wherein
the lower arm fastening structure comprises a lower arm support component supporting the lower arm and a bracket connecting and fixing the lower arm support component and the subframe, and
the lower arm support component extends along an axial direction and supports the lower arm by a rotatable manner in the axial direction, and the bracket supports the lower arm support component in the up-down direction and has an open cross section opening toward the lower arm support component in the up-down direction.

2. The vehicle structure according to claim 1, wherein
the lower arm fastening structure is disposed on one of the two lower arm fastening portions which is closer to the bending position.

3. The vehicle structure according to claim 1, wherein
the bracket has a wall portion, and
the wall portion extends perpendicularly to the axial direction of the lower arm support component and joins to the lower arm support component.

4. The vehicle structure according to claim 3, wherein
the bracket has a rib portion, and
the rib portion extends from the wall portion along the axial direction and joins to the lower arm support component.

5. The vehicle structure according to claim 1, wherein
the bracket has a through hole located on a lowermost portion in the up-down direction.

6. The vehicle structure according to claim 1, wherein
the bracket comprises an upper bracket supporting the lower arm support component from an upper side in the up-down direction, and a lower bracket supporting the lower arm support component from a lower side in the up-down direction, and
the upper bracket and the lower bracket are fastened to the subframe.

7. The vehicle structure according to claim 1, wherein
the lower arm support component comprises a sleeve portion surrounding an outer peripheral side of the lower arm, and an outer cylinder surrounding an outer peripheral side of the sleeve portion, and
the lower arm support component supports the lower arm with the sleeve portion, and connects to the bracket with the outer cylinder.

8. The vehicle structure according to claim 2, wherein
the bracket has a wall portion, and
the wall portion extends perpendicularly to the axial direction of the lower arm support component and joins to the lower arm support component.

9. The vehicle structure according to claim 2, wherein
the bracket has a through hole located on a lowermost portion in the up-down direction.

10. The vehicle structure according to claim 2, wherein
the bracket comprises an upper bracket supporting the lower arm support component from an upper side in the up-down direction, and a lower bracket supporting the lower arm support component from a lower side in the up-down direction, and
the upper bracket and the lower bracket are fastened to the subframe.

11. The vehicle structure according to claim 2, wherein
the lower arm support component comprises a sleeve portion surrounding an outer peripheral side of the lower arm, and an outer cylinder surrounding an outer peripheral side of the sleeve portion, and
the lower arm support component supports the lower arm with the sleeve portion, and connects to the bracket with the outer cylinder.
